(19) United States
(12) Patent Application Publication
(10) Pub. No.: US 2021/0381312 A1
(43) Pub. Date: Dec. 9, 2021

(54) A STABILISER SYSTEM FOR A COLLAPSIBLE LADDER

(71) Applicant: Telesteps AB, Tranås (SE)

(72) Inventor: Rikard MATTSSON, Aneby (SE)

(73) Assignee: Telesteps AB, Tranås (SE)

(21) Appl. No.: 17/285,329

(22) PCT Filed: Oct. 14, 2019
(86) PCT No.: PCT/EP2019/077821

§ 371 Date: Apr. 14, 2021

(30) Foreign Application Priority Data
Oct. 17, 2018 (SE) 1851270-7

(51) Int. Cl. E06C 7/42; E06C 1/12; E06C 7/08

(52) U.S. Cl. CPC E06C 7/423; E06C 7/086; E06C 7/083; E06C 1/125

(57) ABSTRACT

A stabiliser system (150; 160; 170; 180) for use with at least one ladder tube (10, 12) of a collapsible ladder (1) wherein the collapsible ladder (1) comprises at least two ladder sections (6, 5a-5j) and where each ladder section comprises two ladder tubes (10, 12) arranged parallel to each other and interconnected by a rung (20) to form the respective ladder section, and where each ladder tube (10, 12) is telescopically inserted into a ladder tube (10, 12) of a lower ladder section to form the collapsible ladder (1) is provided. The stabiliser system (150; 160; 170; 180) comprises at least two bracket sections (110a-b, 112a-b; 120a-b, 122a-b) each arranged to receive a respective ladder tube (10, 12), and two elongated portions (130a-b) being connected to at least one bracket section (110a-b, 112a-b; 120a-b, 122a-b), wherein each elongated portion (130a-b) is configured to be arranged in a retracted position (71) and a deployed position (72), wherein in the retracted position (71) each elongated portion (130a-b) is arranged substantially parallel to the respective ladder tubes (10, 12).

### TECHNICAL FIELD

The present invention relates to a stabiliser system for use in a ladder section of a collapsible ladder comprising several ladder sections, where each ladder section comprises two ladder tubes arranged parallel to each other and interconnected by a rung to form the respective ladder section. The present invention also relates to an improved telescopic or collapsible ladder or a stepladder.

### BACKGROUND

As well known by persons skilled in the art of collapsible ladders, such ladders usually comprise a number of tube portions having various diameters and which hence are telescopically insertable into one another. Every upper end of any of the tube portions are fastened to one end of a ladder step, whereas the other end of the ladder step is fastened to an upper end of a tube portion having the same diameter, the two tube portions and the ladder step forming a ladder section, the tube sections of which being insertable into an adjacent ladder section comprising tube portions having a larger diameter.

The resulting ladder may hence be collapsed by inserting higher ladder sections into lower ladder sections, and the ladder can be extended by extracting higher ladder sections from the lower ladder sections. A pin extending through the holes in the outer walls of two adjacent tube portions locks the tube portions to prevent the extended ladder from collapsing. Ladders having collapsible and expandable ladder sections are used in order to make the ladder smaller for storage and transport purposes.

In order to increase the safety of using ladders, a stabiliser system may be used. Prior art stabiliser systems such as WO2017212401, WO2017103649, and EP3186464 all have several problems. One common problem is that they are bulky, which goes against the purpose of using a collapsible ladder instead of a non-collapsible ladder.

It is the object of the present invention to provide a stabiliser system for a ladder without the problem mentioned above.

### SUMMARY OF INVENTION

An object of the present invention is to provide a stabiliser system for use in a ladder section of a collapsible ladder, which lowers the bulkiness and increases the durability.

According to a first aspect, a stabiliser system for use with at least one ladder tube of a collapsible ladder is provided. The collapsible ladder comprises at least two ladder sections and where each ladder section comprises two ladder tubes arranged parallel to each other and interconnected by a rung to form the respective ladder section, and where each ladder tube is telescopically inserted into a ladder tube of a lower ladder section to form the collapsible ladder, wherein the stabiliser system comprises at least two first bracket sections each arranged to receive a respective ladder tube, and two elongated portions being connected to at least one first bracket section, wherein each elongated portion is configured to be arranged in a retracted position and a deployed position, wherein in the retracted position each elongated portion is arranged substantially parallel to the respective ladder tubes.

In one embodiment, each bracket section is arranged with an attachment member for connecting the at least one bracket section to the elongated portion. The attachment member may comprise or be connected to a pivot point configured to pivotally move the elongated portions between the retracted and deployed positions.

The system may further comprise at least two articulated arms each being arranged at its first end to its respective elongated portion and at its second end to the attachment member of its respective bracket section.

In one embodiment, the system further comprises at least two second bracket sections arranged to receive the respective ladder tubes, wherein the at least two second bracket sections are arranged below the at least two first bracket sections.

Each elongated portion may comprise a first part and second part, and wherein the first part of each elongated portion is arranged to the ladder by the first bracket section and wherein the second part of each elongated portion is arranged to the ladder by the lower bracket section.

In one embodiment, the elongated portion comprises a first section and a second section, wherein the first section has a smaller outer diameter than the inner diameter of the second section and wherein the first section is telescopically inserted into the second section to form a collapsible elongated portion.

In one embodiment the ladder comprises at least first and a second rung, and wherein the first bracket sections are arranged in conjunction with the first rung and the second bracket sections are arranged in conjunction with the second rung, and wherein the first rung is arranged above the second rung.

The second rung may be the lowermost rung of the ladder. The first rung may be the second lowermost rung of the ladder.

In one embodiment, the first bracket sections are part of the first rung, and/or the second bracket sections are part of the second rung. In an alternative embodiment, the first bracket sections are arranged above or below the first rung, and the second bracket sections are arranged above or below the second rung.

In one embodiment, the elongated portions each has a length that is longer than the length of one ladder section.

In one embodiment, when the elongated portion is arranged in the retracted position, one end of the elongated portion is arranged in a position that is lower than the position of the end portions of the ladder tubes. More specifically, the end portion of the elongated portion is arranged in a position that is lower than the position of the end portion of the ladder tube when the elongated portion is arranged in the retracted position.

In one embodiment, in the retracted position, each elongated portion is arranged with an angle from each ladder tube.

In one embodiment, in the retracted position, the elongated portions are arranged in the same plane as the longitudinal direction of the rungs of the ladder.

In a second aspect, a bracket section for a stabiliser system for use with at least one ladder tube of a collapsible ladder is provided. The bracket section is arranged to receive a ladder tube, and wherein the bracket section is connected to an elongated portion which is configured to be arranged in a retracted position and a deployed position, wherein in the retracted position each elongated portion is arranged substantially parallel to the respective ladder tubes.

In a third aspect, a collapsible ladder comprising several ladder sections is provided. Each ladder section comprises two ladder tubes arranged parallel to each other and interconnected by a rung to form the respective ladder section, and where each ladder tube is telescopically inserted into a ladder tube of a lower section to form a collapsible ladder, wherein the ladder comprises a stabiliser system according to the first aspect.

In a fourth aspect, a collapsible stepladder comprising a first and a second ladder leg is provided. The legs are hingedly connected to each other in one end, and where each of the ladder legs comprises several ladder sections, each section comprising two ladder tubes arranged parallel to each other and interconnected by a rung to form the respective ladder section, and where each ladder tube is telescopically inserted into a ladder tube of a lower section to form a collapsible ladder, wherein the ladder comprises a stabiliser system according to the first aspect.

One benefit of the stabiliser system herein is that the end portion of the ladder always is in contact with a support surface when the stabiliser system is in the deployed position. Hence, the stabiliser system does not need to be configured to hold the weight of a user when in use.

Other objectives, features and advantages of the present invention will appear from the following detailed disclosure, from the attached claims, as well as from the drawings. It is noted that the invention relates to all possible combinations of features.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

### BRIEF DESCRIPTION OF THE DRAWINGS

In the following, the invention will be explained with reference to the accompanying drawings, where:

FIGS. 1a-b show front views of an extended ladder (FIG. 1a) and of a maximally collapsed ladder (FIG. 1b) according to an embodiment;

FIGS. 2a-b show different views of a rung according to an embodiment;

FIGS. 3a-b show different views of a bracket according to an embodiment;

FIGS. 4a-b show different views of a bracket according to another embodiment;

FIG. 5a-b show a stabiliser system in a retracted position (FIG. 5a) and in a deployed position (FIG. 5b) according to an embodiment;

FIG. 6a-b show a stabiliser system in a retracted position (FIG. 6a) and in a deployed position (FIG. 6b) according to an embodiment;

FIG. 7 shows a stabiliser system in a deployed position according to an embodiment; and

FIGS. 8a-c show a stabiliser system in a retracted position (FIG. 8a) and in an intermediate position (FIG. 8b) and in a deployed position (FIG. 8c) according to an embodiment.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

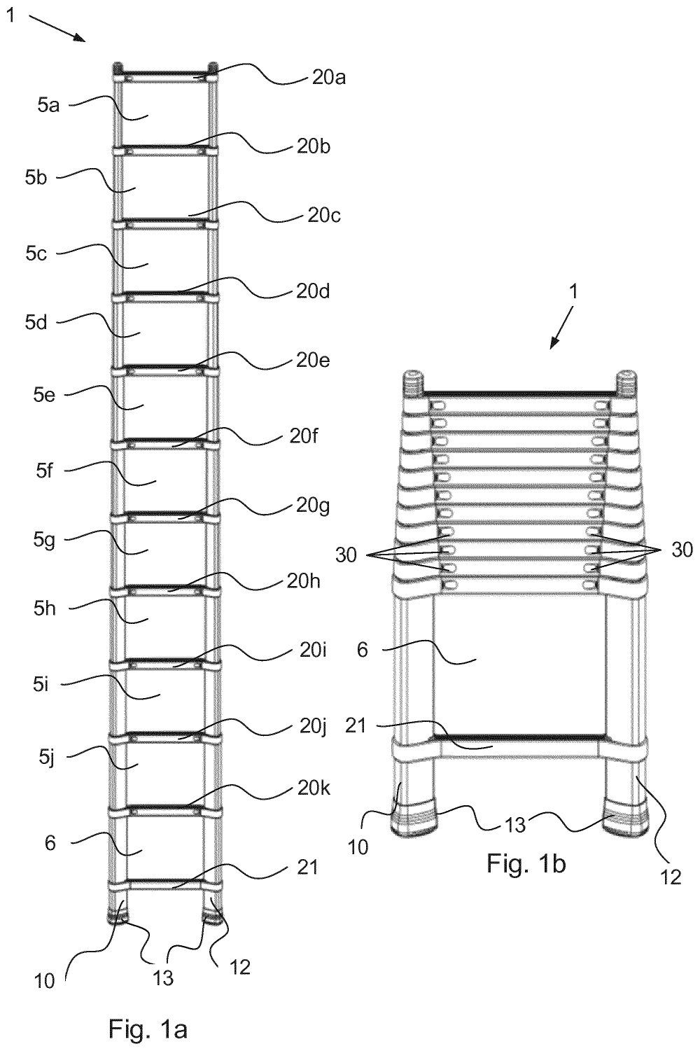

In FIG. 1a, a collapsible ladder 1 is shown in a fully extended state. The collapsible ladder 1 comprises several ladder sections 5a-j where each ladder section 5a-j comprises two ladder tubes 10, 12 and one rung 20a-k. The ladder sections are in a U-shaped form where the two ladder tubes 10, 12 are arranged parallel to each other and are interconnected at one end by one rung 20a-k. The rungs 20a-k are arranged horizontally between the vertically arranged ladder tubes 10, 12. The ladder tubes 10, 12 are divided into sections 5a-j, which telescope into each other. A section arranged higher than another lower section (for example, section 5a is arranged higher than section 5b) has an outer diameter which is smaller than the inner diameter of the lower section. This allows the higher section to telescope inside the tube section between an extended state and a collapsed state.

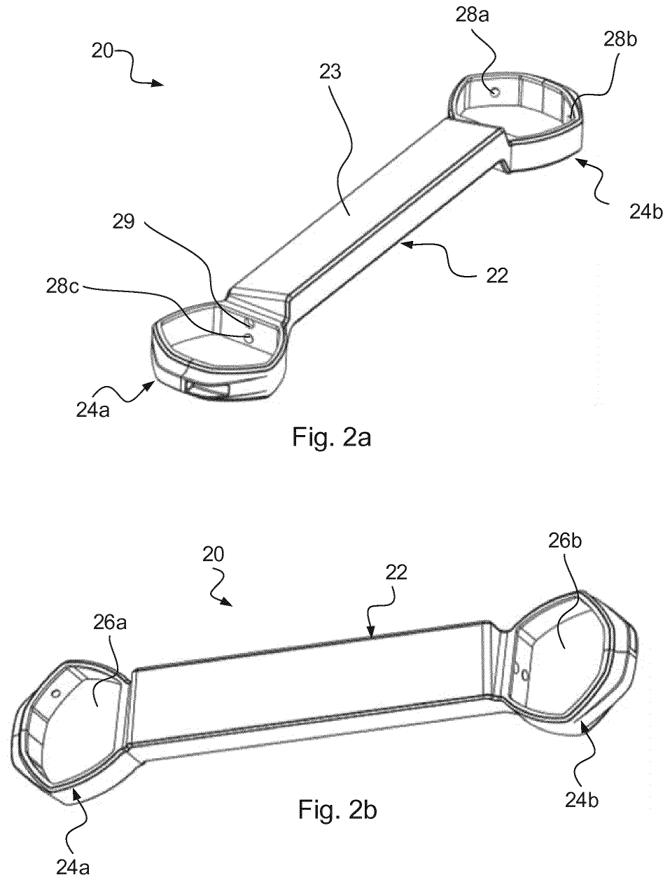

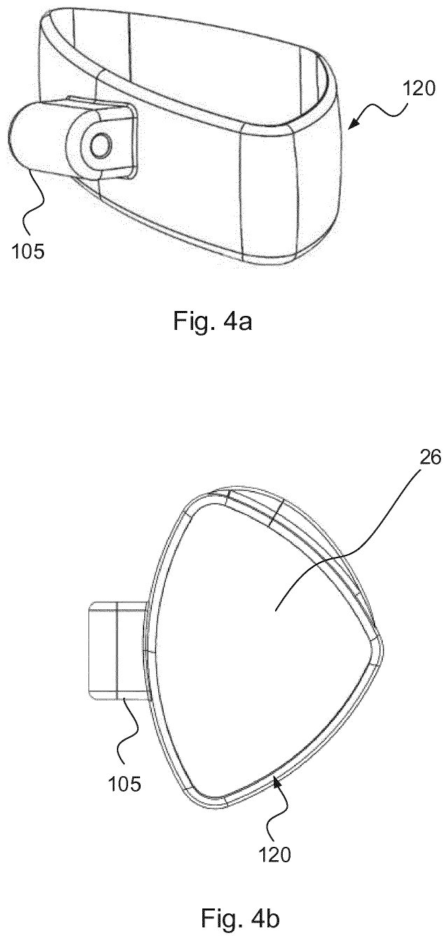

The ladder tubes 10, 12 may comprise any number of mounting holes. The holes may for example be manufactured using punching, drilling, milling or electrical discharge machining Each mounting hole corresponds to a rung protrusion 28a-c (see FIG. 2a-b) arranged on each bracket section 110a, 110b of the rung 20, the cooperation between the mounting hole and the rung protrusions 28a-c allows the rung 20 to be securely arranged on the ladder tube 10, 12. It should also be noted that the tubes 10, 12 may comprise more holes, for example fastening holes for devices preventing the ladder from being accidently pulled apart or fastening holes for bracket sections used to connect a stabiliser system 150; 160; 170; 180 as discussed further in relation to FIGS. 4-8.

A maximally collapsed ladder is shown in FIG. 1b. The lowermost ladder section 6 comprises a stationary rung 21, which is provided at the bottom of the ladder, designed to provide an extra foot support and a more stable lowermost ladder section 6. A seen in FIG. 1b, the lowermost ladder section 6 is stationary and cannot be telescoped into the other sections 5a-j. The lowermost ladder section 6 may comprise two rungs, the stationary rung 21 and the rung 20k.

The ladder tubes 10, 12 may be provided with end portions 13 on which the ladder stands. The end portions 13 are thus arranged at the lowest part of the ladder tubes 10, 12. The end portions 13 may be arranged with a material of high friction, thus lowering the risk of the ladder 1 moving during use.

In order to telescopically collapse and expand the ladder, a locking or retaining mechanism may be provided. In the embodiment shown in FIGS. 1a-b, a retaining mechanism comprises a plurality of actuators 30 arranged on each individual rung 20a-k in order to release the respective sections 5. The retaining mechanism comprise a spring-loaded locking pin (not shown) which locks a ladder section 5a in relation to another adjacent ladder section 5b by being inserted into locking holes in the ladder tube. Each section 5a-j is individually released by using actuators 30 (such as rotary buttons or slide buttons) arranged on both sides of the rung 20. By using the actuators 30, for example sliding slide buttons towards each other, the locking pins are withdrawn from the respective locking holes in the ladder tube 10, 12.

In one embodiment, the ladder only comprises one pair of actuators, which for example are arranged on the front side of the second lowermost rung. The single pair of actuators will still be able to collapse the entire ladder. Alternatively, the ladder comprises a first pair of actuators arranged on the second uppermost ladder rung and a second pair of actuators arranged on a rung positioned between the second uppermost rung and the second lowermost rung. The second pair of actuators enables the lowering of a lower part of a collapsible ladder and the first pair of actuators enables the lowering of an upper part of the collapsible ladder. Such actuators are described in the European patent EP1728966, which is hereby incorporated by reference.

In a further embodiment, the pin of the lowest ladder section may be withdrawn from interaction with its respective holes in the tubes of the neighbouring ladder section by manipulating a foot control located and arranged to maneuvered by a foot of a user of the ladder.

It should be noted that although only some types of locking/retaining mechanisms are mentioned herein, any type of mechanism suitable to collapse and expand a telescopic ladder could be used.

FIG. 2a-b shows an embodiment of a rung 20 in different perspective views. Each rung 20 comprises a main section 22, a first bracket section 110a and a second bracket section 24b. The first and second bracket sections 24-b are arranged at each end of the rung 20 to receive the respective ladder tube 10, 12.

Each bracket section 24a-b is arranged with an opening 26a, 26b having the same shape as the cross-sectional shape of the corresponding ladder tube 10, 12. The cross-sectional shape of the ladder tube 10, 12 may have a distinctive form. The cross-sectional shape of the openings 26a, 26b in FIGS. 2a-b comprises in total six sections; a straight section and five additional sections.

In one embodiment, the cross-sectional shape comprises at least one straight section and at least one additional section. The cross-sectional shape may have any number of additional sections. The number of additional sections may be one, two, three, four, five, six and so on. The section or sections may comprise one side. The additional section/sections may be straight, concave, convex or otherwise rounded. Furthermore, the cross-section may be symmetrical or asymmetrical. The straight section of the ladder tube 10, 12 may be arranged in the bracket section so that it is facing the main section 22. It should be noted that any kind of cross-sectional shape of the ladder tube 10, 12 could be used.

The two bracket sections 24a-b may be identical and symmetrical to one another, i.e. the first bracket section 24a could be arranged on either the first or second ladder tube 10, 12.

The rung 20 may be provided as a single integrated unit, where the main section 22, the first bracket section 24a and the second bracket section 24b are one single piece. The main section 22 and the first and second bracket sections 24a-b may be formed by the same material. The material may be a thermoplastic material such as for example a polyamide (nylon). The material may be reinforced by adding compositions of glass fibres.

In another embodiment, the first bracket section 24a and the second bracket sections 24b are provided as separate units attached to the main section of the rung for example by means of press fit.

The main section 22 of the rung 20 may be slightly inclined to provide a more user-friendly ladder 1. In one embodiment, the main section 22 is inclined with an angle with respect to a horizontal plane, the may range between 10 and 20 degrees, and more preferably around 15 degrees. The main section 22 of the rung comprises a step surface 23, which is the surface that the user is intended to place their feet on during use of the ladder.

In one embodiment, the rung 20 comprises three rung protrusions 28a-c arranged to fit the three mounting holes of the ladder tube 10, 12. This secures the rung 20 to the ladder tube 10, 12. The rung protrusions 28a-c are each arranged on the rung 20 so that it corresponds to the mounting holes of the ladder tube 10, 12.

In one embodiment, the rung 20 comprises a rung locking hole 29 which together with the locking hole is used to receive a locking pin (not shown) used in the locking mechanism of the ladder 1.

The rung 20 shown in FIGS. 2a-b does not comprise any actuators 30. This may be the case where only the second lowermost rung in ladder 1 has a pair of actuators 30 which are manually operated (such as a rotary button or a slide button) and all the other rungs are collapsed automatically by operating the actuator 30 of the second lowermost rung. However, it should be understood that the rung 20, if used in the stabilizing system 150; 160; 170; 180; 180,' could be arranged with a pair of actuators 30 (as shown in FIGS. 1a-b). In that case, the two actuators 30 are arranged in conjunction with the two bracket sections 24a-b. A spring-loaded locking pin (not shown) may be arranged in the rung locking hole 29 of the rung 20, in a preferred embodiment the spring-loaded locking pin is arranged on the straight section of the rung 20.

In one embodiment the collapsible ladder 1 comprises locking indicators (not shown) on all or some rungs 20a-k. The locking indicator may have a green field to indicate that the locking mechanism associated with that locking indicator is activated and/or a red field to indicate that the locking indicator is inactivated. Alternatively the locking indicator can be arranged as coloured portions of the locking pin.

Collapsible ladders 1 such as have been described above may be very tall and possibly unstable. In order to use these safely, it is preferred if the ladder is connected to a stabiliser system that stabilises the ladder and/or provides balance to the user of the ladder. Prior art stabiliser systems have several problems, one of the biggest being that they are not compact, which negates the main benefit of a collapsible ladder 1. A stabiliser system 150; 160; 170; 180 that eliminates or at least reduces these problems is thus provided.

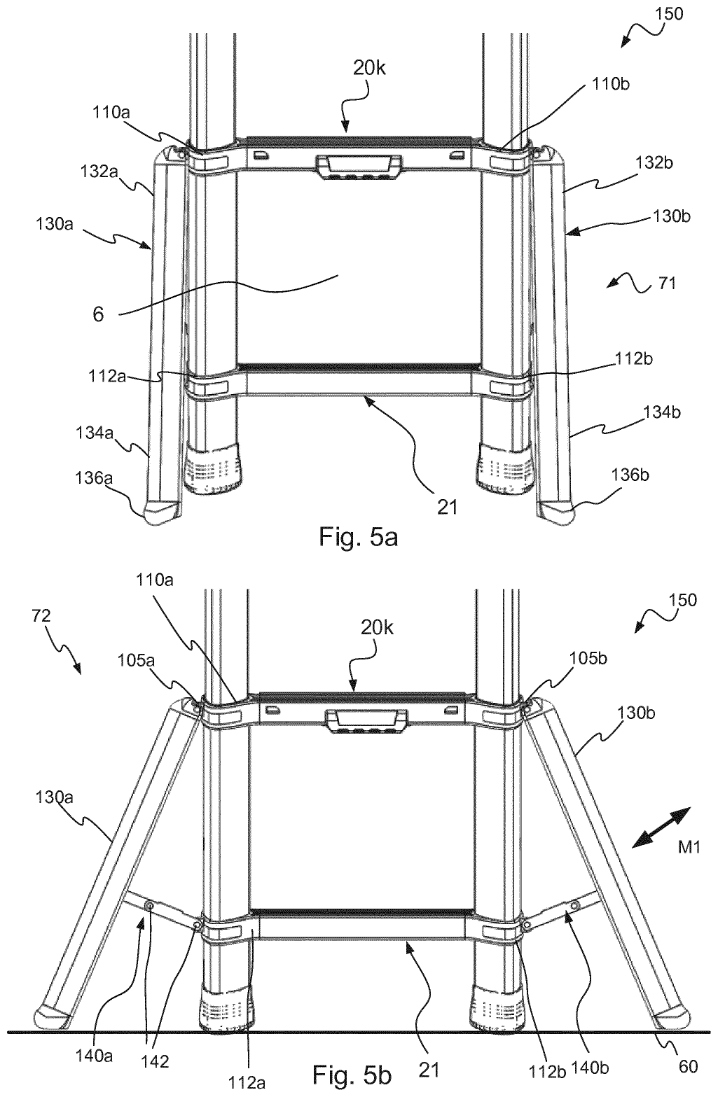

The stabiliser system preferably comprises at least one bracket section arranged to receive a ladder tube 10, 12. As will be described more in detail with reference to FIGS. 5-8, the at least one bracket section is connected to an elongated portion which is configured to be arranged in a retracted position and a deployed position. In the retracted or resting position the elongated portion is arranged substantially parallel to the ladder tube. In the deployed position the elongated portion is arranged in a position that is not parallel to the ladder tube in order to provide stabilisation to the ladder. In a preferred embodiment the stabiliser system comprises two bracket sections, one arranged for each ladder tube 10,12.

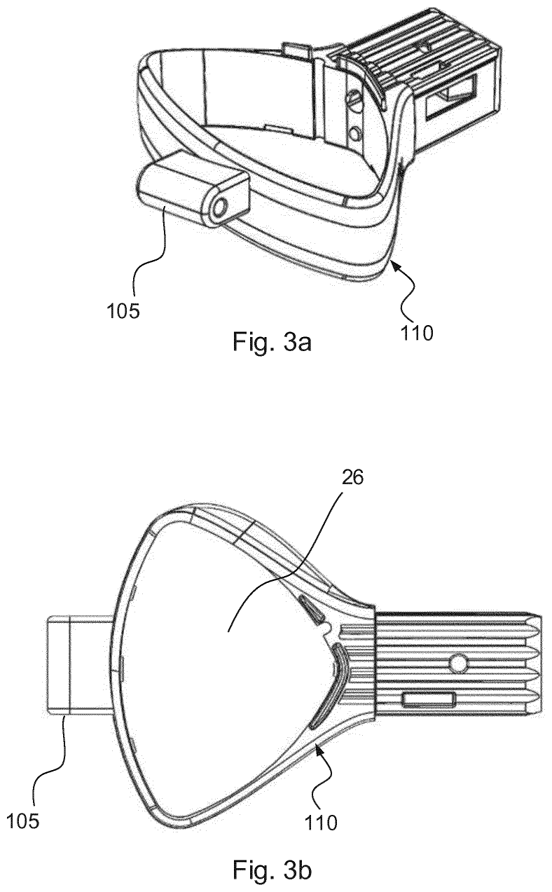

As will now be described with reference to FIGS. 3 and 4, different kinds of bracket sections 110a-b, 112a-b; 120a-b, 122a-b may be used in the stabilizer system 150; 160; 170; 180. The bracket sections could either be part of the rung 20, as shown in FIGS. 3a-b, or be a separate bracket section 120a-b that is not directly connected to a rung 20, as shown in FIGS. 4a-b.

FIGS. 3a-b show a bracket 110 for use in a stabiliser system according to a first embodiment. Here, the stabiliser bracket 110 forms a part of the rung 20 as shown in FIG. 2a-b. The stabiliser bracket 110 may be integrally formed with the rung 20 or be formed as a separate part being connectable to the rung 20.

The bracket section 110 comprises an opening 26 arranged to receive a ladder tube 10, 12. The bracket 110 further comprises an attachment member 105. The attachment member 105 is arranged at the outer side of the bracket 110, facing away from the opening 26. Moreover, in this embodiment the attachment member 105 is arranged on the opposite side of the main section 22 of the rung 20. The attachment member 105 is arranged to connect the bracket section with an elongated portion 130a-b (as shown in FIG. 5-8). The attachment member 105 may be a hinge, a through hole for a pin or any other attachment that allows the stabilizer system to be moved between at least two positions. If a pin is used, the pin may be arranged in conjunction with the elongated portion 130a-b. The movement is performed by moving the elongate member 130a-b or any other part between the two positions.

The attachment member 105 may be arranged in integral with the bracket section 110 or as to separate parts being connected to each other.

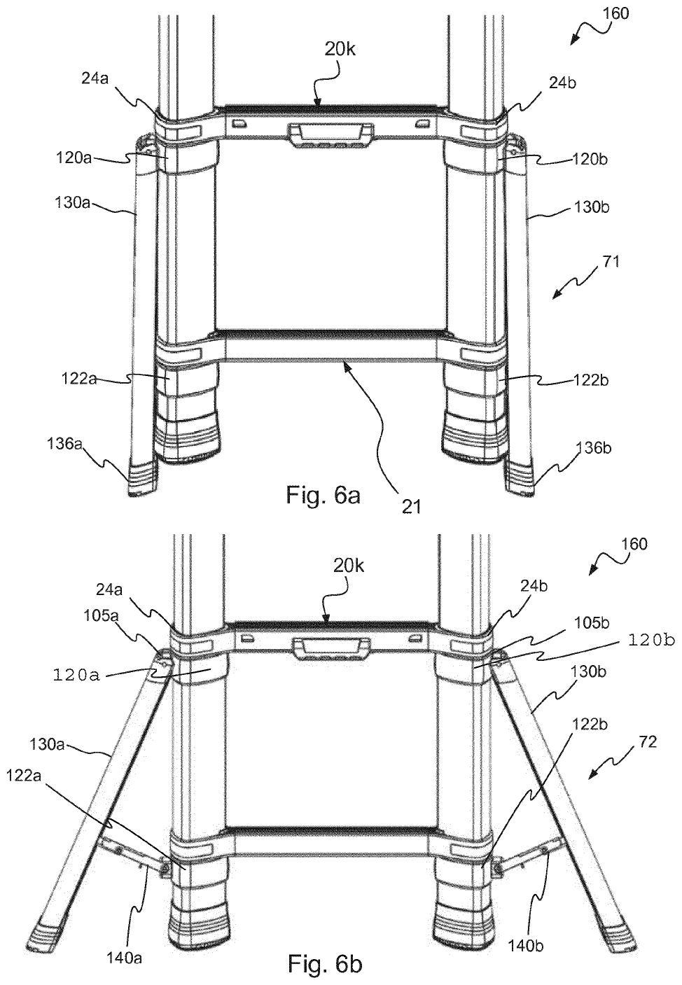

FIGS. 4a-b show a bracket section 120 for use in a stabiliser system according to a second embodiment. The bracket section 120 is not part of a rung 20. The bracket section 120 may be arranged below a rung 20 (as shown in FIGS. 6a-b) or above a rung 20.

The bracket section 120 comprises an opening 26 arranged to receive a ladder tube 10, 12. The bracket section 120 further comprises an attachment member 105. The attachment member 105 is arranged at the outer side of the bracket 120, facing away from the opening 26. Moreover, in this embodiment the attachment member 105 is arranged on the side that is not facing the rungs of the ladder 1. The attachment member 105 is arranged to connect the bracket section with an elongated portion 130a-b (as shown in FIG. 5-8). As previously described, the attachment member 105 may be a hinge, a through hole or any other attachment that allows the elongated portion 130a-b to be moved between at least two positions. The attachment member 105 may be arranged in integral with the bracket section 120 or as to separate parts being connected to each other.

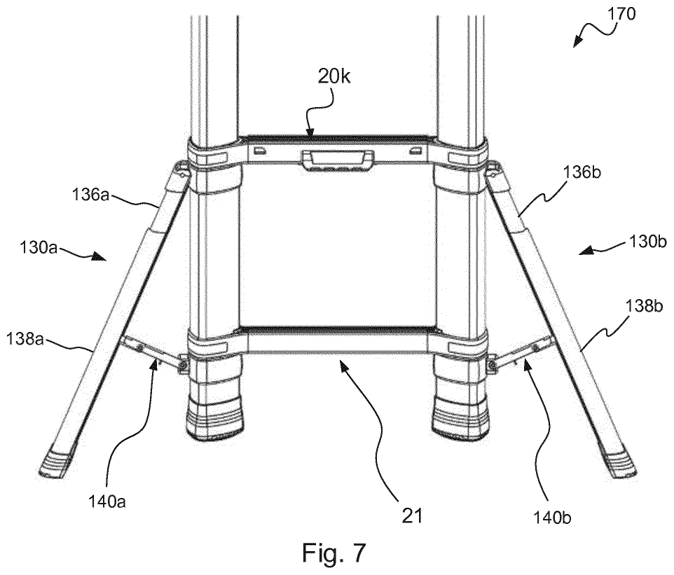

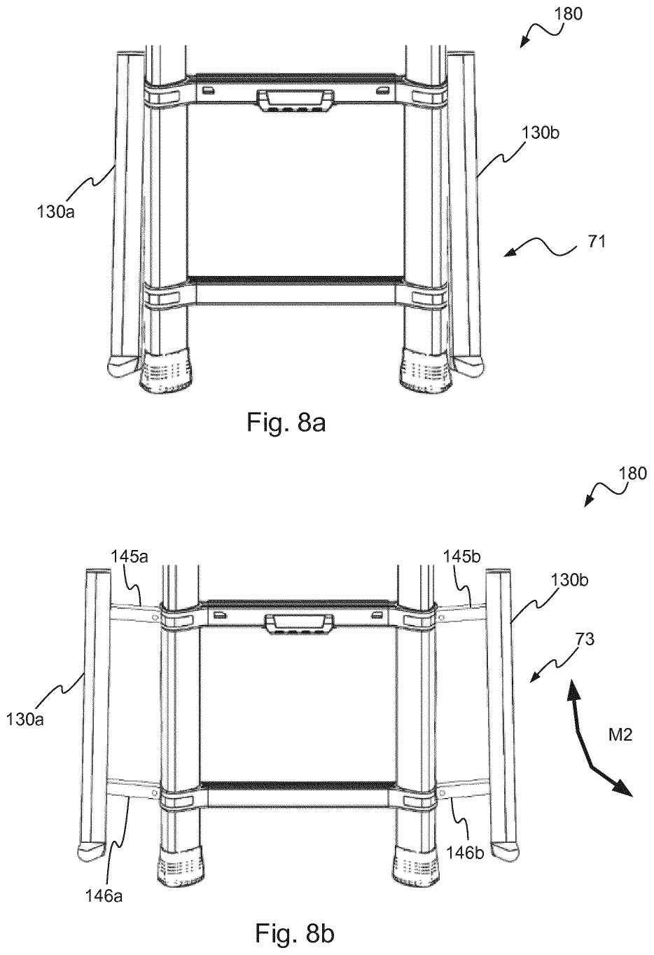

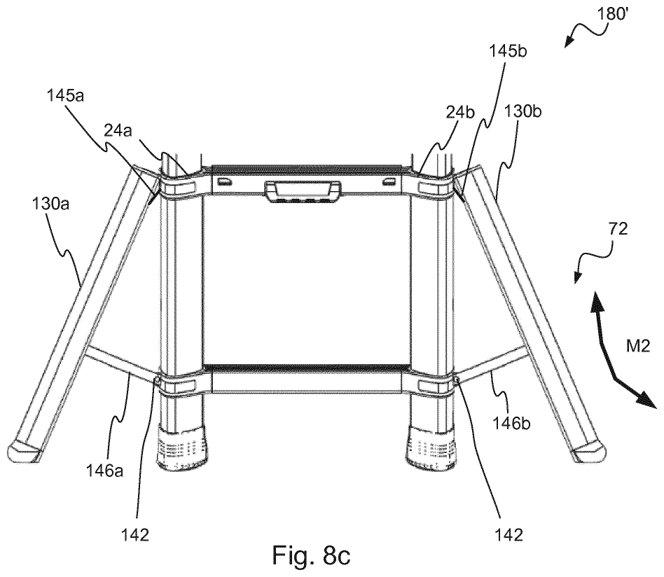

Different stabiliser systems 150; 160; 170; 180 will now be described more in detail with reference to FIGS. 5-9, where FIGS. 5a-b illustrates a stabiliser system 150 comprising brackets being integrated with a rung 20 as shown in FIGS. 3a-b and where FIGS. 6a-b illustrates a stabiliser system 160 comprising brackets as shown in FIGS. 4a-b. FIG. 7 illustrate a further embodiment of a stabiliser system 170 where the elongated portions are telescopically arranged, and FIGS. 8a-c illustrates yet one embodiment of a stabiliser system 180.

As previously mentioned, the stabiliser system 150; 160; 170; 180 comprises at least one bracket section 110a-b, 112a-b; 120a-b, 122a-b arranged to receive a ladder tube 10, 12. The system further comprises at least one elongated portion 130a-b being connected to at least a part of the at least one bracket section 110a-b, 112a-b; 120a-b, 122a-b.

The elongated portion comprises a first part 132a-b and a second part 134a-b. The first and second part may be the ends of the elongated portion, but could also be different parts of the extent of the elongated portion. The first part 132a-b of the elongated portion 130a-b is either directly or indirectly arranged to the ladder 1 by a first bracket section 110a-b; 120a-b. The second part 134a -b of the elongated portion 130a-b is either directly or indirectly arranged to the ladder 1 by a second bracket section 112a-b; 122a-b. The connection between the elongated portion and the bracket sections will soon be described more in detail.

The first and the second bracket sections may be identical to each other or be different from each other. The first bracket section is arranged at a position on the ladder tube 10,12 that is above the second bracket section.

In the embodiments shown in FIGS. 5-8, the first bracket section is arranged at the second lowermost ladder rung 20k (FIGS. 5a-b, FIGS. 8a-c) or just below the second lowermost ladder rung 20k (FIGS. 6a-b). However, it should be understood that the first bracket section could further be arranged just above the second lowermost ladder rung 20k. Moreover, in alternative embodiments the first bracket section could be arranged at, just below or just above any of the lowermost ladder rungs (such as ladder rungs 20j, 20i and 20h).

The second bracket section is arranged at the lowermost ladder rung 21 (FIGS. 5a-b, FIGS. 8a-c) or just below the lowermost ladder rung 21 (FIGS. 6a-b, FIG. 7). However, it should be understood that the second bracket section could further be arranged just above the lowermost ladder rung 21. Moreover, in alternative embodiments the second bracket section could be arranged at, just below or just above any of the lowermost ladder rungs (such as ladder rungs 20k, 20j and 20i).

One end of the elongated portion 130 comprises an end portion 136a-b configured to be in contact with a support surface 60 when the stabiliser system 150 is in the deployed position 72. The support surface 60 may be a floor, wall, steps of a staircase or similar. The end portion 136a-b may be arranged with a material of high friction.

The elongated portion 130 may be solid or at least partly hollow. In order to save material, it may be beneficial for the elongated portion 130 to be hollow. On the other hand, by making the elongated portion 130 solid, its strength may be increased. The cross-sectional shape of the elongated portion 130 may be symmetrical or asymmetrical. It may for example have a cross-sectional shape as discussed before in relation to FIGS. 2a-b. The cross-sectional shape of the elongated portion 130 may be similar to or different from the cross-sectional shape of the ladder tube 10, 12. The cross-sectional shape may be optimised to fit in certain openings or stay in certain positions, or to simplify manufacturing. In one embodiment, as for example shown in FIG. 5a and FIG. 5b, when the elongated portion is arranged in the refracted position, the end portion 136a-b of the elongated portion is arranged in a position that is lower, i.e. closer to the ground, than the position of the end portion 13 of the ladder tube. This provides a high usability since the stabiliser system ensures that the user is using the stabiliser system in the right way. The position of the elongated portions makes it impossible, or at least very hard, to use the stabilising system when it is not in its deployed position. Moreover, the collapsible ladder is only standing on its surface when the stabiliser system is in its deployed position, which also provides a high safety for the user. Hence, the system has two clear distinct positions; a deployed position and a retracted position.

The at least one elongated portion 130a-b is configured to be arranged in a retracted position 71 and a deployed position 72. In the retracted position 71 the at least one elongated portion 130a-b is arranged substantially parallel to the ladder tubes 10, 12. When the stabiliser system 150 is arranged in a retracted position 71, as shown in FIGS. 5a, 6a and 8a, it does not provide stabilisation to the ladder 1. In the refracted position 71, the stabiliser system 150 is arranged to be compact, for example suitable for transportation. To this end, the elongated portion 130 may be configured to be parallel to the side of the ladder 1 or configured to be parallel to a rung 20 in the retracted position 71. The stabiliser system 150 is shown in a deployed position 72 in FIGS. 5b, 6b, FIG. 7. In the deployed position, the stabiliser system 150 provides stabilisation to the ladder 1. The configuration of the retracted position is especially beneficial since the elongated portion is arranged at a position being below, i.e. closer to the ground, than the end portions 13 of the ladder.

In one embodiment the elongated portion 130a-b has a length that is longer than the length of one ladder section 6, 5a-5j. In alternative embodiment, the length of the elongated portions is the same or smaller than the length of one ladder section. In this embodiment, when the elongated portion is not longer than the length of the ladder section, it is worth specifying that the end portion 136a-b of the elongated portion can still be arranged in a position that is lower than the position of the end portion 13 of the ladder tube when the elongated portion is arranged in the retracted position.

The stabiliser system 150 can be moved between the retracted position 71 and the deployed position 72. This movement is preferably performed by a user of the ladder 1, for example by a foot of a user of the ladder 1. Due to the arrangement of the stabilizer system 150 it is possible to move the stabilizer system between the two positions 71, 72 without using the hands. This has several benefits as the user can use the hands for other things, which in turn increase the safety and usability of the ladder.

As shown in the embodiments of FIGS. 5-8, the system 150; 160; 170; 180 preferably comprises two parts (referenced a and b in the figures), a first part being arranged for the first ladder tube 10 and a second part being arranged for the second ladder tube 12. The first part is preferably the same as the second part, being a mirror version of the other. Hence, the first part comprises one elongated portion 130a and at least one bracket section being configured to receive the first ladder tube 10. More preferably the first part comprises a first and a second bracket section 110a, 112a; 120a, 122a where both are configured to receive the first ladder tube 10. Similarly, the second part comprises one elongated portion 130b and at least one bracket section 110b, 112b; 120b, 122b being configured to receive the second ladder tube 12. More preferably the second part comprises a first and a second bracket section 110b, 112b; 120b, 122b where both are configured to receive the second ladder tube 12. It is thus preferred if the stabiliser system comprises an elongated portion for each ladder tube 10, 12 so as to provide a more stable ladder system.

A first embodiment of a stabiliser system 150 is shown in FIGS. 5a-b. In this embodiment the stabiliser system comprises brackets 110 being integrated with a rung 20, as shown in FIGS. 3a-b.

A second embodiment of a stabiliser system 160 is shown in FIGS. 6a-b. In this embodiment the stabiliser system comprises brackets 120 that are not the same as the brackets arranged to receive a rung 20. Hence, the brackets 120 in this embodiments are the same or similar to those shown in FIGS. 4a-b.

In both FIGS. 5-6, the elongated portion 130a-b is connected to a first bracket 110a; 120a and a second bracket 110c; 120c. The first part of the elongated portion 130a-b is connected to the first, upper, bracket 110a; 120a by connecting it to the attachment member 105 of the bracket 110a; 120a. The connection may be in the form of a hinge construction.

The second part of the elongated portion 130a-b is connected to the second, lower, bracket 110c; 120c. In the embodiments of FIGS. 5-6, the elongated portion 130a-b is connected to the attachment member 105 of the bracket 110c; 120c via an arm 140a, 140b. The arm 140a is preferably an articulated arm. The articulated arm may have one or more pivot points 142. In a preferred embodiment the arm has two pivot points 142. The articulated arm 140a allows the elongated portion 130a to be moved between a retracted and deployed position. Moreover, the articulated arm 140a, 140b controls the movement of the elongated portion. In this way the elongated portion can not be put in an unallowable position. The retracted position 71 and the deployed position 72 are thus clearly defined positions. Hence, the elongated portion can not be moved into a “more” deployed position by moving the elongated portion further up and/or by moving the elongated portion in an direction away from the ladder that is nto supported by the arm 140a, 140b.

The articulated arm 140a, 140b further has the benefit that it can be easily controlled using the foot. The user just presses the articulated arm 140a, 140b downwards and then lightly presses the outer sides of the elongated portions. Hence, no hands are needed making the stabiliser system easy to use and control.

FIG. 7 shows a stabiliser system 170 according to yet one embodiment. In this embodiment, the stabiliser system 170 is collapsible, in the same way as the ladder 1 may be. The elongated portion 130a-b comprises a first section 136a-b and second section 138a-b. The first section 136a-b of each elongated portion 130a-b is arranged to the ladder 1 by a first, upper, bracket section 110a-b; 120a-b and the second section 138a-b of each elongated portion 130a-b is arranged to the ladder 1 by a second, lower, bracket section 112a-b; 122a-b.

The first section 136a-b of each elongated portion 130a-b has a smaller outer diameter than the inner diameter of the second section 138a-b. This allows the first section 136a-b to be telescopically inserted into the second section 138a-b to form a collapsible elongated portion 130a-b. This allows adjustment of the length of the elongated portion 130a-b. This may be beneficial to provide stabilisation on an uneven support surface 60 such as a slope or a staircase.

It should be noted that the telescopical function of the elongated portion 130a-b could be applied to both embodiments shown in FIGS. 5-6.

FIGS. 8a-b illustrates a stabiliser system 180 according to yet one embodiment, where FIG. 8a shows a stabiliser system 180 being arranged in a deployed position 72 and FIG. 8b shows a stabiliser system 180 being arranged in a retracted position 71. In this embodiment, the connection between the elongated portion and the first and second brackets are different from those described in relation to FIGS. 5a-b. The difference in connection allows for a different movement pattern between the retracted and deployed position, as shown by the arrow reference M1 (FIGS. 5b) and M2 (FIG. 8b).

The first part of the elongated portion 130a-b is connected to the first, upper, bracket 110a; 120a. The elongated portion 130a-b is connected to the attachment member 105 of the bracket 110a; 120a via a first arm 145a. The second part of the elongated portion 130a-b is connected to the second, lower, bracket 110c; 120c. The elongated portion 130a-b is connected to the attachment member 105 of the bracket 110c; 120c via a second arm 146a.

The first and second arms 145a, 146a are preferably articulated arms. The articulated arm may have one or more pivot points, preferably arranged in one or both of the end points of the arm. The articulated arm 145a, 146a allows the elongated portion 130a to be moved between a retracted and deployed position according to the movement pattern illustrated by the arrow denoted M2. In order to move between the retracted 71 and deployed 72 position the elongated portion 130 may be extendable away from the brackets 110 to move between FIGS. 8a and 8b. Alternatively or additionally, the elongated portion 130 may be slideable along the side of the ladder 1 to move between a retracted position 71 where the elongated portion 130a-b is not in contact with the support surface 60 and a deployed position 72 where the elongated portion 130a-b is in contact with the support surface 60. More specifically, the end portion 136a-b of the elongated portion 130a-b is not in contact with the support surface 60 in the retracted position and the end portion 136a-b of the elongated portion 130a-bis in contact with the support surface in the deployed position.

In an intermediate position where the system is between the retracted and the deployed position, as shown in FIG. 8b, the elongated portion 130, the side of the ladder 1 and the two arms 145a, 146a will form a parallelogram. With pivot points arranged at each end of each rod arm 145a, 146a the parallelogram is adjustable between a retracted position 71, where the end portion 136a-b is not in contact with the support surface 60, and a deployed position 72, where the end portion 136a-b is in contact with the support surface 60.

FIG. 8c illustrates the system in a deployed position. It should be noted that the system can be arranged in the sequence retracted position, intermediate position and finally the deployed position. In an alternative embodiment the intermediate position is not present, and the system is arranged to be moved directly between the refracted and the deployed positions.

Even though it has not been shown by the detailed embodiment or the drawings it is evident that the claimed stabiliser system may be used on a stepladder. A collapsible stepladder comprises a first and a second ladder leg. The legs are hingedly connected to each other in one end, and each of the ladder legs can be seen as an individual collapsible ladder.

1. A stabiliser system for use with at least one ladder tube of a collapsible ladder that includes at least two ladder sections, each ladder section having two ladder tubes arranged parallel to each other and interconnected by a rung to form the respective ladder section, and each ladder tube being telescopically inserted into a ladder tube of a lower ladder section to form the collapsible ladder, wherein the ladder tubes of a lower most ladder section each are arranged with an end portion, the stabiliser system comprising:
at least two first bracket sections each arranged to receive a respective ladder tube; and
two elongated portions connected to at least one first bracket section, each elongated portion configured to be arranged in a retracted position and a deployed position;
wherein each elongated portion has an end portion configured to be in contact with a support surface when the elongated portion is in the deployed position; and
wherein in the retracted position, each elongated portion is parallel to the respective ladder tubes and the end portions of the elongated portions are in a position that is lower than the position of the end portion of the ladder tube.

2. The stabiliser system according to claim 1, wherein each bracket section is arranged with an attachment member for connecting the at least one bracket section to the elongated portion.

3. The stabiliser system according to claim 2, wherein the attachment member includes or is connected to a pivot point configured to pivotally move the elongated portions between the retracted and the deployed positions.

4. The stabiliser system according to claim 2, further comprising:
at least two articulated arms, each articulated arm including first end attached to a respective elongated portion and a second end attached to the attachment member of a respective bracket section.

5. The stabiliser system according to claim 1, further comprising:
at least two second bracket sections arranged to receive the respective ladder tubes;
wherein the at least two second bracket sections are arranged below the at least two first bracket sections.

6. The stabiliser system according to claim 5, wherein each elongated portion comprises a first part and a second part;
wherein the first part of each elongated portion is arranged to the ladder by the first bracket section; and
wherein the second part of each elongated portion is arranged to the ladder by the second bracket section.

7. The stabiliser system according to claim 1, wherein each elongated portion comprises a first section and a second section;
wherein the first section has a smaller outer diameter than an inner diameter of the second section; and
wherein the first section is telescopically inserted into the second section to form a collapsible elongated portion.

8. The stabiliser system according to claim 1, wherein the elongated portions each has a length that is longer than the length of one ladder section.

9. The stabiliser system according to claim 1, wherein in the retracted position, the elongated portions are arranged in a same plane as a longitudinal direction of the rungs of the ladder.

10. The stabiliser system according to claim 1, wherein the elongated portions each are arranged to be maneuverable between the retracted position and the deployed position by a foot of a user of the ladder.

11. (canceled)

12. A collapsible ladder comprising:
several ladder sections, each ladder section having two ladder tubes arranged parallel to each other and interconnected by a rung to form the respective ladder section, each ladder tube being telescopically inserted into a ladder tube of a lower section; and
a stabiliser system according to claim 1.

13. A collapsible stepladder comprising:
a first ladder leg and a second ladder leg that are hingedly connected to each other at one end, each of the ladder legs including several ladder sections, each ladder section having two ladder tubes arranged parallel to each other and interconnected by a rung to form the respective ladder section, and each ladder tube being telescopically inserted into a ladder tube of a lower section; and
a stabiliser system according to claim 1.

14-21. (canceled)
